(19) United States
(12) Patent Application Publication
(10) Pub. No.: US 2007/0227417 A1
(43) Pub. Date: Oct. 4, 2007

(54) Process and equipment for the treatment of waste material

(75) Inventors: Adolfo Lopez Aguayo, San Andres del Rabanedo (Leon) (ES); Avelino Encina Canal, Leon (ES); Pascal Haxaire, Leon (ES)

Correspondence Address: BUCHANAN, INGERSOLL & ROONEY PC, POST OFFICE BOX 1404, ALEXANDRIA, VA, 22313-1404, US

(73) Assignee: RECUPERACION MATERIALES DIVERSOS, S.A., Ardoncino (ES)

(21) Appl. No.: 11/409,119

(22) Filed: Apr. 24, 2006

(30) Foreign Application Priority Data
Apr. 3, 2006 (IB) PCT/IB06/00770

(51) Int. Cl. A47J 36/00; F23G 5/12; F23K 3/18

(52) U.S. Cl. 110/246; 110/276; 110/229

(57) ABSTRACT

A chamber for treating waste material includes a substantially closed chamber which is horizontally elongate with a conveyor provided within the chamber oriented generally horizontally and defining an upper portion and a lower portion with a series of paddles arranged to move material along the upper portion of the conveyor. A material supporting surface formed of ceramic material is provided between the upper portion and the lower portion of the conveyor. The material supporting surface is generally U-shaped and forms a channel through which the paddles move along the upper portion of the conveyor. The material supporting surface is carried by a plurality of metal horizontal support members which are cooled by a fluid. The paddles are asymmetrically oriented with respect to the conveyor.

The present application claims priority to International Application No. PCT/IB2006/000770 filed on Apr. 3, 2006, the entire content of which is hereby incorporated by reference

### FIELD OF THE INVENTION

The present invention relates to equipment and methods for the treatment of waste materials using relatively high temperature, especially to such equipment and methods for use in processing waste materials such as tires and a recovery of energy from the waste materials, and especially to the recovery of energy from an organic portion of such waste materials.

### BACKGROUND OF THE INVENTION

Various methods and equipment are known from the prior art for the treatment of waste materials using relatively high temperature. In the prior art, the term thermolysis is sometimes used to identify such methods especially where the waste materials are broken up into simpler constituents (i.e., dissociated) in the absence of any significant amount of oxygen. Such thermolytic plants for the thermal dissociation of waste material oftentimes operate at a reduced air pressure and include a reactor which operates at relatively high temperature, for example at a temperature of between 400° C. and 1000° C., and especially at a temperature of about 500° C., under a pressure of between about 0.1 and 1 atmosphere.

Various arrangements and processes according to the prior art for thermolysis are disclosed in, for example, U.S. Pat. No. 6,244,199 of Chambe et al. Other patent publications concerning thermolysis and waste treatment by way of heat include U.S. Patent Publication No. 2003/0196884 of Dell'Orfano, U.S. Pat. No. 6,178,899 of Kaneko et al., U.S. Pat. No. 6,051,110 of Dell'Orfano et al., U.S. Pat. No. 5,728,196 of Martin et al., U.S. Pat. No. 5,505,822 of Martin et al., U.S. Pat. No. 5,302,254 of Martin et al., and U.S. Pat. No. 4,878,440 of Tratz et al.

Additional patent publications disclosing various processes for thermolysis and for the treatment of waste material by heating include: EP 0 934 489; WO 98/17950; WO 96/11742; FR 2 837 495; FR 2 785 835, FR 2 785 835; FR 2 754 883; FR 2 762 613; FR 2 725 643; FR 907.054 and JP 2003-230875.

In the prior art, it is well known to treat waste materials, including waste materials having an organic portion, by thermolysis. In addition, it is well known to treat waste materials including, for example, discarded automobiles which have been shredded, i.e., automobile shredder residues (ASR), hospital and biological waste materials, discarded tires, “green” waste or biomass waste, municipal and domestic waste materials, and sludge from sewage treatment plants and from various petroleum products. Despite prior attempts to treat such waste materials using thermolysis, the volume of waste materials requiring treatment as well as the cost of providing and operating equipment to treat such waste materials using thermolysis presents a continuing and increasing problem to be solved.

In the known equipment, however, various problems remain which prevent or discourage the utilization of such equipment and processes for commercial operation. For example, the efficient and economical operation of such equipment and processes for commercial purposes generally requires a relatively high throughput and waste processing rate. The equipment and processes according to the prior art for thermolysis do not facilitate a lengthening or elongation of the equipment because such elongation typically results in an undesirable deformation and uncontrolled expansion of various components.

For example, in the equipment disclosed in FR 2 785 835, the mechanism for conveying the waste material through the equipment is formed of metallic alloys. The components of the conveying mechanism have relatively large dimensions and undergo significant deformation when operating at the relatively high temperatures common in such equipment. Those deformations present problems with the operation of a motorized conveying mechanism at high temperature using components made of metallic alloys.

In addition, the use of metallic alloys for various components of the conveying mechanism results in wear by reason of abrasion. The extent of such abrasion is increased and more significant due to the high temperatures at which such components operate. Consequently, these problems prevent or discourage the enlargement or elongation of the equipment which, in turn, limits the throughput or capacity of the equipment.

Throughput of such waste treatment equipment cannot be increased merely by operating the conveying mechanism at higher speed. Instead, the length of the equipment must also be increased so that the process time for the waste material within the equipment is maintained. In addition, some waste materials require significantly longer time within the thermolysis equipment than other waste materials. If the speed of the waste material through the equipment is slowed to increase the process time, the capacity or throughput of the equipment is reduced. If the speed of the waste material through the equipment is maintained, the process time may be increased by increasing the length of the equipment.

As a result, the throughput of the waste treatment equipment depends upon the speed of the conveying mechanism through the equipment as well as the length of the processing chamber. An increase in the size of the components used in the equipment together with the relatively high operating temperatures of such equipment present problems with the use of metallic alloys for various components due to the resulting expansion and deformation.

Accordingly, it is an object of the present invention to provide a process and equipment for the efficient and economical treatment of relatively large amounts of waste materials by thermolysis. In a preferred embodiment of the present invention, the equipment is elongated in order to provide a relatively large throughput or treatment capacity.

In order to increase the process time of the waste material without increasing the length of the overall equipment, some prior art devices (such as FR 2 785 835) provide for the waste material to travel twice through the equipment by providing two channels within the equipment with one channel provided above the other channel. A chain conveyor moves the waste material first along the upper channel in one direction and then along the lower channel in the reverse direction. However, such an arrangement presents problems with fouling resulting from the generation of particles while the waste material falls from the upper channel to the lower channel.

In other words, having the waste material fall from the upper channel to the lower channel presents a significant risk of fouling or clogging of the conveying system. Since the chain moves the waste material in both directions (i.e., forward along the upper channel and rearward along the lower channel) the channels are configured to only utilize one half of the height of the conveyor panels.

In general, a problem exists with the use of an endless conveyor because such equipment tends to foul over time. Such fouling is more problematic in the case of furnaces or reactors for the continuous treatment of waste material, since the waste material typically is treated in non-uniform sizes and compositions.

Moreover, in thermolysis equipment fouling can affect the conveying system as well as the heating system and/or the ventilation system for the equipment. Such fouling can result in costly down time for repairs or for additional maintenance and servicing of the equipment as well as increased costs for the repair and replacement of components.

The various components of the thermolysis equipment are continuously exposed to relatively high temperatures as well as to an atmosphere which contains highly reactive materials such as chlorine and sulfur which has a reducing and corrosive effect on the materials conventionally used for such equipment components.

### SUMMARY OF THE INVENTION

In a preferred embodiment of the present invention, a chamber for treatment of waste material comprises a substantially closed chamber which is horizontally elongate. A conveyor is provided within the substantially closed chamber oriented generally horizontally and defining an upper portion and a lower portion. The conveyor has a series of paddles arranged to move material along the upper portion of the conveyor. A material supporting surface is provided between the upper portion and the lower portion of the conveyor with the material supporting surface being arranged beneath the upper portion of the conveyor and formed of ceramic material.

In the preferred embodiment, the material supporting surface is formed of ceramic cement, especially of refractory ceramic cement. The material supporting surface is generally U-shaped and forms a channel through which the paddles move along the upper portion of the conveyor. The material supporting surface is carried by a plurality of horizontal support members which extend transversely across the chamber with the plurality of horizontal support members being made of metal.

A passageway is provided for supplying a fluid in thermal contact with at least one of the plurality of horizontal support members and preferably a passageway for supplying a fluid is provided in thermal contact with each of the plurality of horizontal support members.

An inlet is provided whereby a discrete batch of waste material may be periodically supplied to the conveyor with an arrangement to substantially prevent oxygen from entering said chamber.

In the preferred embodiment, an arrangement is provided to heat the interior of the chamber with piping to collect gases given off by the waste material while being conveyed through the chamber. An arrangement is also provided to collect remaining waste material from a downstream end of the conveyor and the arrangement to heat the interior of the chamber comprises a plurality of electrical resistance heating elements arranged into individually controlled groups. An arrangement is also provided to collect remaining waste material from an upstream end of the conveyor.

In the preferred embodiment, an arrangement is provided to recover thermal energy from the fluid after passing through the passageways in thermal contact with the plurality of horizontal support members.

In the preferred embodiment, the paddles are asymmetrically oriented with respect to the conveyor and the conveyor comprises first and second chains with the paddles provided between the first and second chains. The paddles are oriented perpendicularly with respect to the first and second chains. A relatively large portion of each of the paddles extends perpendicularly from the chains toward the material supporting surface. A second supporting surface is provided beneath the lower portion of the conveyor with a relatively small portion of each of the paddles extending perpendicularly from the chains away from the material supporting surface.

Preferably, the relatively small portion of each of the paddles urges remaining waste material along the second supporting surface and into the arrangement to collect remaining waste material from the upstream end of the conveyor to prevent fouling of the conveyor.

Preferably, the first and second chains slide on ceramic bearing surfaces provided longitudinally within the chamber and carbon formed during heating of the waste material within the chamber provides lubrication for the chains of the conveyor on the bearing surfaces. An arrangement recovers gases from an upper portion of the chamber and a combustion chamber is provided for burning the recovered gases and combustible carbonized product. An arrangement supplies at least a portion of the combustible carbonized product from the chamber to the combustion chamber.

An arrangement is provided for recovering thermal energy from combustion gases and an arrangement is provided for removing pollution from the combustion gases with the electrical resistance heaters heating the chamber to about 550° C. and more preferably to about 525° C.

### BRIEF DESCRIPTION OF THE DRAWING FIGURES

FIG. 1 is a schematic side view of equipment for heating waste material to produce combustible gases and carbonized product.

FIG. 2 is a schematic view of equipment for burning the combustible gases and a portion of the carbonized product which result from heating the waste material.

FIG. 3 is a side view in partial cross-section of an arrangement for heating waste material according to a preferred embodiment of the present invention.

FIG. 4 is a side view in partial cross-section of a portion of the arrangement for heating waste material of FIG. 4.

FIG. 5 is a view through the line A-A of FIG. 3.

FIG. 6 is a view through the line B-B of FIG. 3.

FIG. 7 is a view through the line C-C of FIG. 3.

### DETAILED DESCRIPTION OF THE INVENTION

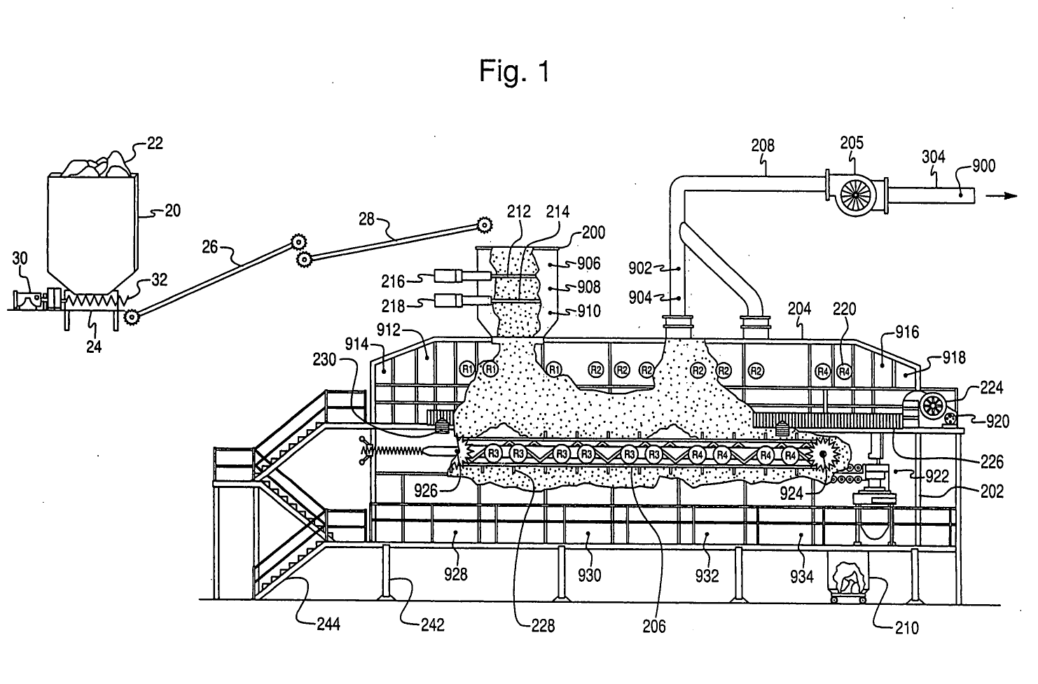

With reference to FIG. 1, equipment for processing waste material 22 by heating the waste material substantially in the absence of oxygen to generate combustion gases includes an arrangement to supply the waste material to a heating chamber 202. The waste material 22 is supplied to a hopper 20 which feeds the waste material 22 to a conveyor 24 such as a screw conveyor 32 which has been provided beneath the hopper 20. Preferably, the waste material 22 has been previously shredded or cut into pieces having a predetermined maximum size so as to facilitate treatment of the waste material in the heating chamber. The maximum size of the waste materials is a matter of choice depending upon the desired processing time of the waste material in the equipment as well as the type of waste material being processed. In the case of used automobile tires, the waste material is preferably shredded into pieces which are no larger than about 6 inches by 6 inches and preferably about 4 inches by 6 inches.

If desired, the waste material can be cut into the pieces of the predetermined maximum size by a mechanical shredder or by another suitable, conventional device (not shown). In the preferred embodiment, the waste material 22 has been cut into pieces of the predetermined maximum size prior to being supplied to the hopper 20 in order to prevent or to minimize any disruption of the supply of waste material to the screw conveyor 32 as a result of an inadvertent jamming or clogging of the shredding mechanism. In addition, by cutting the waste material into relatively small pieces prior to being supplied to the hopper 20, the waste material may be more effectively dried either by storage in a relatively dry environment or by subjecting the shredded waste material to a predetermined drying operation.

The screw conveyor 32 is driven by an electric motor 30 and supplies the waste material to a first belt conveyor 26 which moves the waste material generally upwardly. In the preferred embodiment, a second belt conveyor 28 receives the waste material from the first belt conveyor 26 and moves the waste material toward an inlet 200 of the heating chamber 202. If desired, the waste material may be conveyed from the hopper 20 to the inlet 200 by a single belt conveyor or by another suitable, conventional conveyor such as a screw conveyor or elevator as will be readily apparent to one skilled in the art.

The hopper 20 which supplies the waste material 22 to the conveyor 24 may be filled manually or by a belt conveyor (not shown) or by any suitable, conventional arrangement for loading the hopper 20. The screw conveyor 32 is preferably driven by an electric motor which rotates a screw or auger to drive the waste material horizontally from an outlet of the hopper 20 to the first belt conveyor 26.

The first belt conveyor 26 may be smooth or may have a series of ridges (not shown). Depending upon the inclination of the belt conveyor and the amount of friction provided between the belt surface and the waste material, the ridges or panels provided on the conveyor tend to urge the pieces of waste material upwardly along the first belt conveyor 26. Similarly, the second belt conveyor 28 which receives the waste material from the first belt conveyor 26 may be smooth or provided with a series of ridges (not shown). Both the first and the second belt conveyors may have side walls to prevent the waste material from falling off of the belt conveyors, as desired.

A drive mechanism (not shown) as well as a supporting frame (also not shown) for the belt conveyor are provided for each belt conveyor. The hopper 20 may be located higher or lower than the inlet 200 of the heating chamber 202. In the preferred embodiment, the hopper 20 is located with the outlet of the hopper slightly above ground to accommodate the screw conveyor 32.

The inlet 200 of the heating chamber 202 is provided with a first door 212 and a second door 214 which work together to provide an airlock for the inlet 200. The first door and the second door are operated by separate drive mechanisms such as by hydraulic cylinders 216, 218.

In this way, the first door 212 may be opened to supply a quantity of waste material to an inner compartment of the inlet 200 provided between the first door 212 and the second door 214. The first door 212 is then closed and the second door 214 may be opened to supply the quantity of waste material to the interior of the heating chamber 202. The second door 214 is then closed and the first door 212 may then be opened to supply another quantity of waste material to the inner chamber of the inlet. This sequence is repeated continuously to admit individual batches of waste material onto discrete compartments of a conveyor 206.

By providing the airlock formed by the first and second doors 212, 214, the waste material may be supplied to the interior of the heating mechanism 202 in individual batches without admitting a significant amount of oxygen along with the waste material. The first and second doors 212, 214 need not form a complete seal with the inlet 200 since the introduction of each batch of waste material will typically introduce some air into the furnace along with the waste material. The introduction of a small amount of air containing some oxygen is not problematic and does not produce a significant amount of combustion of the waste material. However, if desired, the interior of the furnace (or at least the inlet 200) may be connected to a source of nitrogen or to a source of an inert gas. In this way, the nitrogen or inert gas would be supplied to the airlock as the waste material is supplied to the airlock formed by the first and second doors 212, 214. The nitrogen or inert gas would displace the ambient air and either completely or substantially prevent oxygen from entering the furnace along with a batch of waste material.

When the batch quantity of waste material enters the interior of the heating chamber 202 through the second door 214, the waste material falls onto a potion of the conveyor 206. The waste material is moved horizontally through the interior of the heating mechanism 202 by the conveyor 206 which has paddles 228 to divide the conveyor into individual sections. The hydraulic cylinders 216, 218 for the first and second doors 212, 214 may be controlled by a suitable, conventional timing mechanism in coordination with the movement of the conveyor 206 to deposit a batch of waste material between adjacent paddles 228 of the conveyor 206 as the adjacent paddles are located directly beneath the second door 214.

The waste material which is processed in the heating mechanism may comprise materials such as shredded tires, biological waste materials, so-called green waste or biomass waste materials, municipal or domestic waste materials, sludge from sewage treatment plants, and petroleum waste materials, as well as numerous other waste materials.

Preferably, the waste material being processed is relatively uniform in composition in order to facilitate the efficient and economical operation of the equipment. In addition, the waste material is preferably cut into pieces having a relatively uniform size so as to minimize the energy and effort needed to treat the waste material in the equipment.

Depending upon the composition of the shredded waste material, it may be desirable to provide a neutralizing agent, such as calcium carbonate, to the waste material before being processed in the equipment. In addition, it may be desirable to store the waste material in a relatively dry environment prior to being processed in order to allow the waste material to dry. The processing of relatively dry waste material reduces the amount of energy required to dissociate the waste material into combustible gases and facilitates the efficient combustion of the gases downstream of the heating chamber.

The waste material is preferably heated in the chamber 202 to a temperature between about 400° C. and about 600° C. and more preferably between about 500° C. and 550° C. The specific temperature which is optimum depends upon the specific composition of the particular waste material. For example, shredded tires are preferably heated to a temperature of about 525° C. The interior of the heating chamber is also preferably at a slightly reduced air pressure below atmospheric pressure (for example, a negative pressure of about −50 mBar) to facilitate the collection of the combustible gases given off by the waste materials. The conveyor is preferably arranged to maintain the waste material within the equipment for about thirty minutes although the specific time may be longer or shorter depending upon the particular waste material being processed as well as on the initial size of the waste material pieces. In this way, both the specific temperature as well as the duration of the heating process for a given batch of waste material within the heating mechanism may be varied depending upon the particular characteristics of the waste material being processed.

If desired, an arrangement (not shown) may be provided to extinguish an inadvertent ignition or combustion of the waste material. For example, provision may be made to supply nitrogen or an inert gas into the interior of the heating chamber in the event that ignition or combustion of the waste material is detected. If desired, the absence of any significant amount of oxygen within the furnace may be obtained by continuously supplying nitrogen or an inert gas into the heating chamber.

The treatment of the waste material by heating in the absence of any significant amount of oxygen typically results in the production of a quantity of gases which are generally combustible and a quantity of solid material or carbonized product which includes both combustible as well as generally non-combustible components.

The interior of the heating chamber 202 is preferably heated by a plurality of electrical heating elements 220 which are arranged in a series of groups that are individually controlled. For example, in the embodiment of FIG. 1, the electrical heating elements are arranged into a first group of three resistance heaters R1 provided immediately below the inlet 200. A second group of six resistance heaters R2 are provided above the conveyor 206 and downstream of the first resistance heaters R1. A third group of six resistance heaters R3 are provided between upper and lower portions of the conveyor 206. The six resistance heaters R3 are provided along an upstream portion of the conveyor 206. A fourth group of six resistance heaters R4 includes two resistance heaters provided above the conveyor 206 and downstream of the six resistance heaters R3 of the second group. Four of the six resistance heaters R4 are provided downstream of the third group of resistance heaters R3 and between the upper and lower portions of the conveyor 206.

In addition to using the groups of resistance heaters to raise the temperature of the heating chamber (and the waste material) to the desired temperature) cooling fluid is provided in order to prevent the supporting structure from overheating. To provide the cooling fluid, a blower 224 supplies cooling air through a conduit 226 to a plurality of passageways 230 provided cross-wise through the middle of the conveyor 206. The air which has passed through the passageways 230 is now relatively hot and may be passed through a heat exchanger (not shown) to recover at least a portion of the thermal energy carried by the air.

If desired, a cooling liquid (rather than a cooling air) may be supplied to the plurality of passageways 230 to cool the supporting structure and to prevent overheating of the heating chamber 202. The passageways 230 as well as the conduit 226 would then be sized appropriately in accordance with the rate at which the cooling liquid is to flow through the heating mechanism 202. The use of a cooling liquid may provide a more uniform control of the temperature of the conveyor as well as facilitating the removal of excess heat from the liquid in a heat exchanger. If desired, the heat exchanger for the cooling liquid or cooling air may be omitted. The cooling air or the cooling liquid (after being heated as a result of flowing through the passageways 230) may be used directly, such as for heating a dwelling or other structure or for some other industrial purpose.

Of course, the heated air may be vented to the atmosphere or the heated liquid, if water, may be discarded without any recovery of thermal energy from the fluid used to cool the conveyor and supporting structure.

Inside the heating chamber 202, the waste material 22 is being heated while being carried longitudinally through the heating chamber by the conveyor 206. The heating of the waste materials is conducted with little or no oxygen present inside the heating chamber 202 so that little or no combustion of the waste material occurs within the heating chamber 202. The waste material is heated to a relatively high temperature (in the absence of any significant amount of oxygen) which is sufficient to cause the waste material to give off combustible gases. The gases are collected from an upper portion 204 of the heating chamber by piping 208. A fan 205 provides a suction or vacuum to facilitate the collection of the combustible gases and then the fan urges the combustible gases through piping 304 provided downstream of the fan 205. In this way, the fan 205 serves as a vacuum pump to draw the combustible gases into the piping 208 and then the fan 205 serves as a blower to drive the combustible gases through the piping 304 to a combustion chamber 300.

In the case of most waste materials, heating in the absence of significant amounts of oxygen typically does not convert all of the waste material to gases. Instead, some volume of a carbonized product usually remains after the heating is completed. The carbonized product from the waste material remains on the upper side of the conveyor 206 provided within the heating chamber 202 until the material reaches the downstream end of the conveyor. The carbonized product is then removed by an extraction system. In the schematic drawing of FIG. 1, the carbonized product is deposited by gravity into a bin 210 which has been provided beneath the downstream end of the heating chamber 202. An airlock (not shown) is preferably provided between the bin 210 and the interior of the heating chamber 202 in order to allow the solid residue to be periodically dumped into the bin 210 (while an upper door of the airlock is closed) without admitting a significant amount of oxygen to the interior of the heating chamber 202.

The gases given off by the waste materials within the heating mechanism 202 are withdrawn from the upper portion of the heating mechanism by the fan 205 which provides a reduced pressure within the piping 208. The piping 208 may have several connections to the upper portion 204 of the heating chamber 202 in order to efficiently and effectively collect the gases given off by the waste material 22 while within the heating chamber 202.

Sensors 906, 908, and 910 are provided within the inlet 200 and additional sensors 912, 914, 916, 918, and 920 are provided within the upper portion 204 of the heating chamber 202 to monitor temperature and pressure. Other sensors 902 and 904 are provided within the piping 208 and sensors 928, 930, 932, and 934 are provided within a lower portion of the heating chamber 202 to monitor pressure and temperature. Sensors 922, 924, and 926 are provided within the interior of the conveyor. The sensed temperatures and pressures are then used to adjust the different groups of electrical resistance heaters as well as to adjust the amount of cooling provided by the cooling air or liquid flowing through the conduit 226.

The heating chamber 202 is preferably raised above ground level in order to provide convenient access to the underside of the heating chamber, for example in order to periodically replace the bin 210 which is full with an empty bin. Accordingly, the heating chamber is preferably mounted on legs 242 which support the underside of the heating chamber 202. Steps 244 are provided at one end of the heating chamber to facilitate easy access to the upper portion of the heating chamber 202 for maintenance and repair.

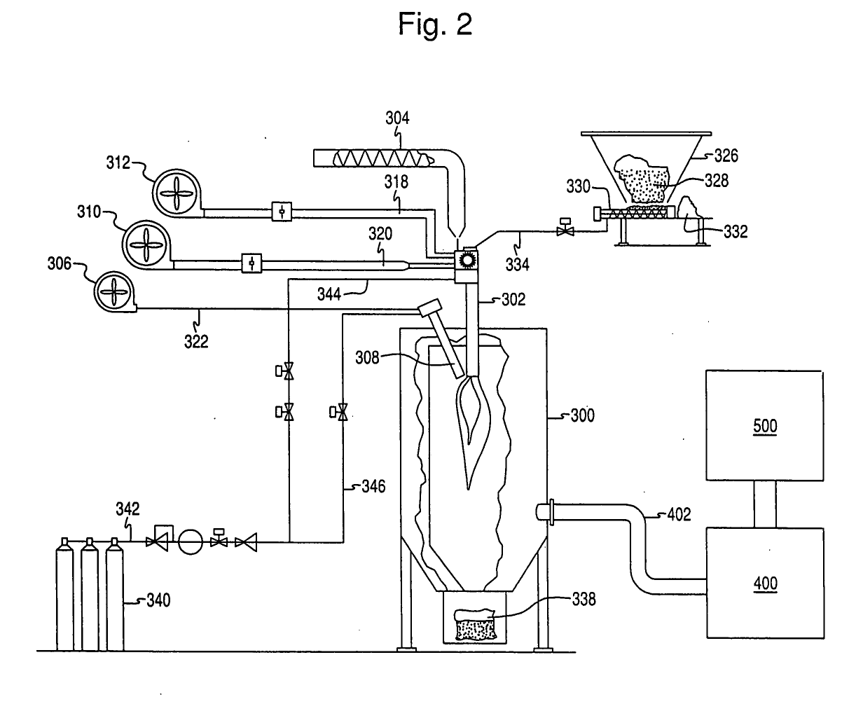

The combustible gases collected from the upper portion 204 of the heating chamber 202 are supplied through the piping 304 to the combustion chamber 300 (see FIG. 2) where the gases are burned. Air is admitted to the combustion chamber 300 along with the gases collected from the upper portion 204 to facilitate burning of the gases. As desired, combustible carbonized product recovered from the residue supplied to the bin 210 may be supplied to the combustion chamber and burned with the gases. The combustible carbonized product is preferably finely ground or pulverized before being supplied to the combustion chamber to promote the burning of the material. If desired, other solid combustible materials as well as other combustible gases may be supplied to the combustion chamber 300 to increase the heat generated in the combustion chamber 300.

The carbonized product may be used directly as additional fuel in the combustion chamber along with the combustible gases recovered from the chamber. The carbonized product is preferably separated into a combustible portion and a non-combustible portion such as by way of a vibratory conveyor or other mechanical separator. The non-combustible portion of the carbonized product can then be further processed in a recycling process. Similarly, the combustible gases recovered from the chamber are preferably burned in a combustion chamber immediately adjacent to the heating chamber. However, it may be preferred in some situations to store the recovered combustible gases for further use as either a raw material or for a fuel source at a remote location.

The combustible gases recovered from the heating chamber are preferably conveyed through the piping 208 and 304 at a relatively high temperature until the combustion gases are injected into the combustion chamber 300. Accordingly, the piping 208 and 304 are preferably insulated and may be provided with electrical resistance heating in order to maintain a desired temperature for the combustible gases while within the piping.

With continued reference to FIG. 2, the combustible gases are supplied through the piping 304 from the heating chamber to an inlet 302 of the combustion chamber 300. Air is supplied to the combustion chamber 300 by a fan 306 which drives air through piping 322 to a pilot burner 308 provided adjacent to the inlet 302 for the combustible gases. The pilot burner 308 facilitates start-up of the combustion chamber as well as the burning of gases during shut-down of the system. Air is also supplied to combustible gases at an upstream portion of the inlet 302 as desired. A primary blower 310 supplies ambient air through piping 320 and a secondary blower 312 supplies heated air from the heating chamber (used to cool the supporting structure for the conveyor) through piping 318 to a mixing chamber provided at the upstream end of the inlet 302.

Although the gases' generated from the heating of the waste materials are generally combustible, it may be desirable to provide an additional source of combustible gas such as propane gas to facilitate ignition of the gases collected from the waste material. By supplying additional combustion gas, the amount of heat provided by the burning of the gas can be regulated and thereby made uniform, if desired. Also, the use of propane may be appropriate during startup operations or when the production of combustible gases is reduced for some reason. Accordingly, tanks of propane gas 340 are provided with piping 342 to supply propane gas to the mixing chamber of the inlet through piping 344 and associated valves and/or to provide propane gas to a mixing chamber of the pilot burner 308 through piping 346 and associated valves.

The carbonized product collected in the bin beneath the heating chamber 202 typically contains a combustible portion 328 as well as a portion which is not readily combustible. Accordingly, the carbonized product collected in the bin may be separated into combustible and non-combustible portions and the combustible portion 328 then supplied to a hopper 326. A screw conveyor 330 which is driven by an electric motor 332 then feeds the carbonized product of the combustible portion 328 through a conduit 334 to the mixing chamber of the inlet 302 to be burned along with the combustion gases. Typically, the carbonized product 328 is first crushed or ground into very small pieces before being mixed with the combustible gases in order to facilitate rapid combustion in the chamber 300.

The combustion of the gases collected from the heating mechanism especially together with a combustible portion of the carbonized product from the bin 210, typically results in a quantity of particulate material at the bottom of the combustion chamber 300. This particulate material is collected in a chamber 338 and is periodically removed and disposed in a suitable manner.

The combustion gases are removed from a lower portion of the combustion chamber through a conduit 402 which conducts the combustion gases into a heat exchanger 400. The blowers 306,310, and 312 urge the combustible gases and air into the combustion chamber 300 under pressure which together with the additional gases formed by the combustion process urges the combustion gases out of the combustion chamber 300 through the conduit 402.

After passing through the heat recovery system, for example a heat exchanger 400, the combustion gases are supplied to an air cleaning system, for example a scrubber 500, to remove pollutants from the combustion gases before being released to the atmosphere.

By passing through the heat exchanger 400 and then through the air pollution control unit 500, the combustion gases have been sufficiently cooled and cleaned that the combustion gases may be vented to the atmosphere without presenting an environmental problem or concern.

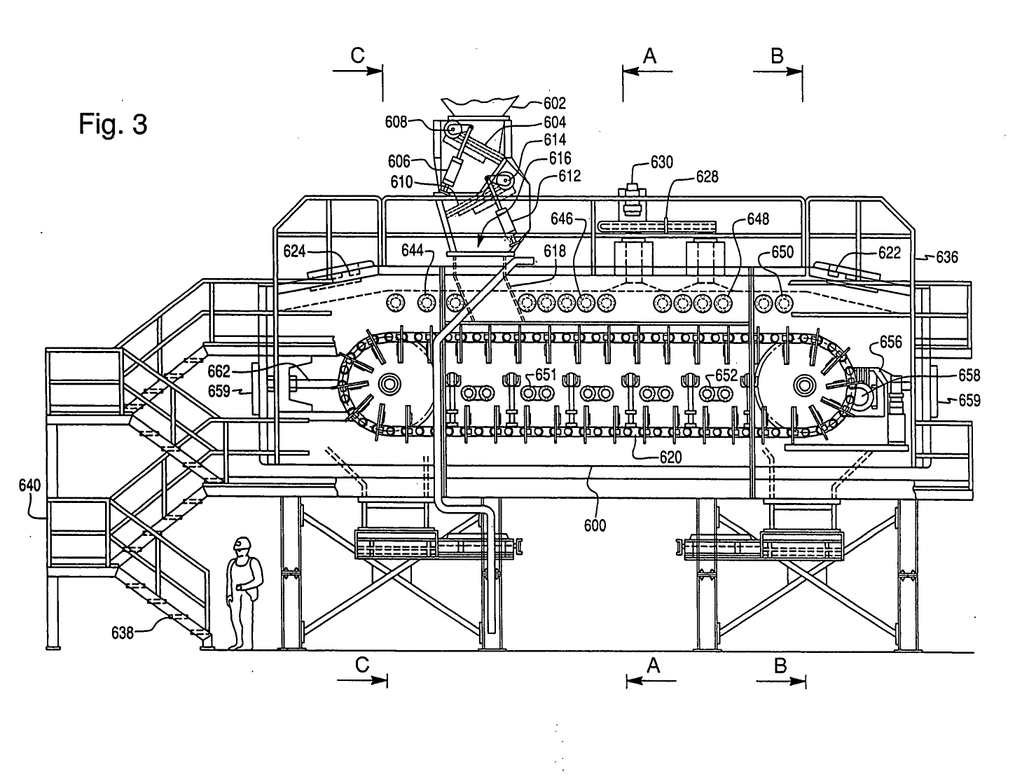

With reference now to FIG. 3, a more preferred embodiment of a heating chamber 600 includes an inlet 602 which receives waste material for processing. The heating chamber 600 may be used in the arrangement of FIGS. 1-2 as the heating chamber 202.

The inlet 602 forms a funnel to direct the waste material toward a first door 604. The first door is opened and closed about a hinge by a hydraulic cylinder 606 which extends and retracts an arm 608 connected to the first door. A second door 610 is provided beneath the first door to form an airlock for the inlet 602. The second door is opened and closed by a second hydraulic cylinder 612 which extends and retracts an arm 614 connected to the second door 610 at a hinge. In this way, the first and second doors provide an air lock for the inlet to supply the waste material in discrete batches to the interior of the heating chamber 600.

As in the heating chamber 202, the waste material is being heated within the heating chamber 600 as the waste material is carried longitudinally by a conveyor 620. The heating of the waste materials is conducted with little or no oxygen present inside the heating mechanism 600 so that little or no combustion of the waste material occurs within the heating mechanism 600. The waste material is heated to a relatively high temperature (in the absence of any significant amount of oxygen) which is sufficient to cause the waste material to give off gases which are collected by a fan 630 through piping 628 from an upper portion of the heating chamber 600.

First and second doors 622, 624 are provided at the upper portion of the heating chamber. Additional doors 659 are provided on either end of the heating chamber to provide access to the interior of the mechanism to a workman or technician. The first and second doors 622, 624 are releasably maintained in a closed configuration such as by weights or by springs in order to provide a pressure release mechanism in the event of an explosion or inadvertent rapid combustion of the gases within the heating chamber 600.

The interior of the heating chamber 600 is preferably heated by a plurality of electrical heating elements which are arranged in a series of groups that are individually controlled. If desired, other heating mechanisms (other than electrical heating elements) could be used to heat the chamber.

In the preferred embodiment of FIG. 3, the electrical heating elements are arranged into a first group of three resistance heaters 644 provided slightly upstream of the inlet 602. A second group of nine resistance heaters include five resistance heaters 646 provided next to one another above the conveyor 620 and immediately downstream of the inlet 602 and downstream of the first resistance heaters 644. In the preferred embodiment, a chute 618 for the inlet 602 extends between the three resistance heaters of the first group and the next five resistance heaters of the second group.

The second group also includes four resistance heaters 648 provided downstream of the resistance heaters 646 and above the conveyor 620. A third group of six resistance heaters 651 are provided between upper and lower portions of the conveyor 620. The six resistance heaters 651 are provided along an upstream portion of the conveyor 620. A fourth group of six resistance heaters includes two resistance heaters 650 provided above the conveyor 620 and downstream of the nine resistance heaters 646, 648 of the second group. Four resistance heaters 652 of the six resistance heaters of the fourth group are provided downstream of the third group of resistance heaters 651 and between the upper and lower portions of the conveyor 620.

Each of the four different groups of resistance heaters is individually controlled so as to facilitate an efficient and uniform heating of the interior of the heating chamber 600 to a predetermined temperature.

In addition to using the groups of resistance heaters to raise the temperature of the heating chamber (and the waste material) to the desired temperature) cooling fluid is provided in order to prevent components of the supporting structure from overheating. The cooling fluid is supplied through a conduit to a plurality of passageways which are provided cross-wise through the middle of the conveyor 620. If the cooling fluid is water, the cooling fluid may be provided, for example, at a temperature of about 15° C. when entering the heating chamber. The cooling water would then leave the heating chamber at a temperature of perhaps 200° C. and could be supplied to a heat exchanger or to another device for recovering thermal energy from the heated water.

Inside of the heating chamber 600, the waste material is being heated while being carried longitudinally through the heating chamber by the conveyor 620. The heating of the waste materials is conducted with little or no oxygen present inside the heating chamber 600 so that little or no combustion of the waste material occurs within the heating chamber. The waste material is heated to a relatively high temperature (in the absence of any significant amount of oxygen) which is sufficient to cause the waste material to give off combustible gases. The gases are collected from the upper portion of the heating chamber by the piping 628. The fan 630 provides a suction or vacuum to facilitate the collection of the combustible gases and then the fan urges the combustible gases through piping provided downstream of the fan.

In order to safely enable workmen to reach the upper portion of the heating chamber 600, stairs 638 are provided from the ground level to the top of the heating chamber. Railings 640 are provided for the stairs and railings 636 are provided for walkways at the upper portion of the heating chamber. An electric motor 656 and associated gearing drive a shaft 658 which powers the conveyor 620.

A tensioning device 662 is provided for the gearwheel of the conveyor at the upstream end of the conveyor. The tensioning device preferably acts on both sides of the conveyor simultaneously and moves the upstream gearwheels longitudinally along the heating chamber to provide the desired tension on the conveyor.

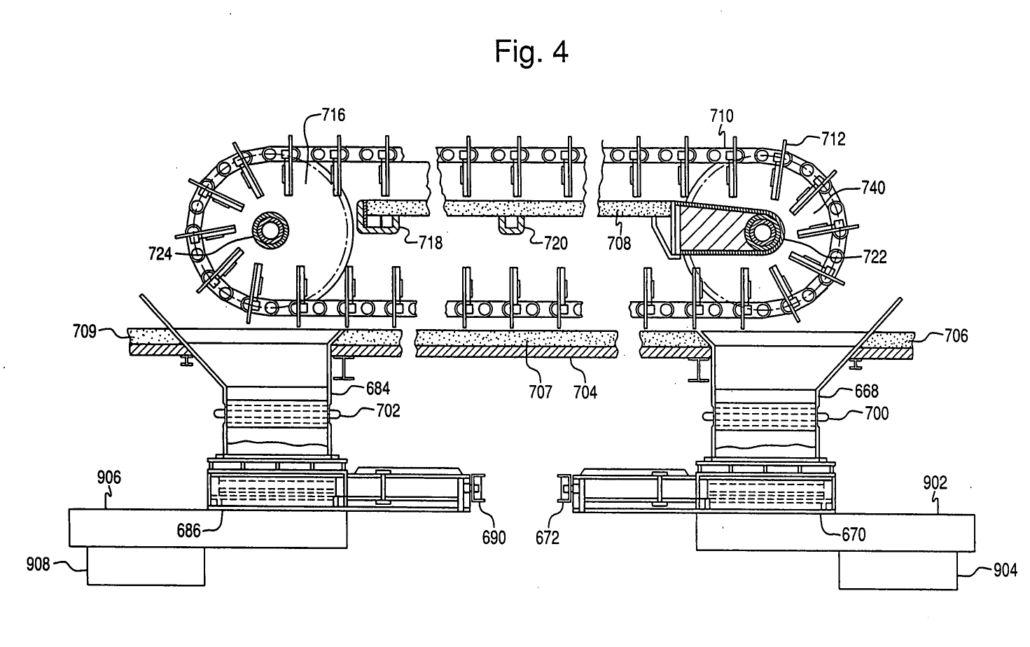

With reference now to FIG. 4, the conveyor is formed by a series of chain links 710 which together form a chain on the left side and the right side of the conveyor. Periodically, chain links carry paddles 712 which extend above and below the level of the chain. Adjacent paddles 712 define compartments for batches of waste material to be urged longitudinally along the heating chamber. The chains of the conveyor and the paddles are configured so that the bottom of the paddles moves slightly above a ceramic bed 708 extending horizontally through the mid section of the heating chamber. The bed 708 formed by the ceramic members provides a generally flat surface along which the waste materials slide as the waste materials are being pushed by the paddles 712 of the conveyor. The paddles are preferably formed of refractory stainless steel and may have ridges to provide additional structural support for the paddles.

In order to support the ceramic bed, horizontal support members 718, 720 which are preferably made of metal, extend cross-wise beneath the bed with passageways for the cooling fluid provided within the support members 718, 720. In this way, the horizontal support members maintain the ceramic bed in a flat configuration. The metal supporting structure enables the ceramic bed and associated conveyor to be positioned properly within the chamber. However, the metal supporting structure would tend to sag and become deformed if the metal supporting structure were subjected to the high temperatures typical within the chamber for extended periods of time. Accordingly, the supporting structure is cooled by the cooling fluid simultaneously while the chamber is being heated (as by the electrical heating elements).

At the downstream end of the ceramic bed, a downwardly sloping end member 722 provides a rampway for any remaining carbonized product to fall downwardly into a chute 668 which directs the remaining carbonized product through a butterfly valve 670. An expansion coupling 700 is preferably formed of a material which does not readily conduct heat in order to both enable the chute 668 and the butterfly valve 670 to handle thermal changes between the chute 668 and the valve 670 and to minimize the transfer of heat from the chute to the valve 670.

A cylinder 672 opens and closes the butterfly valve 670. In the preferred embodiment, a vibratory conveyor 902 is provided below the butterfly valve 670 with one end of the vibratory conveyor receiving the carbonized product from the butterfly valve. When the butterfly valve 670 is open, the carbonized product may pass onto the vibratory conveyor 902 where the carbonized material start to be cooled before reaching a second butterfly valve 904. Then the carbonized product goes to processing equipment such as equipment for the separation of combustible and non-combustible portions.

To discharge the carbonized product, the first butterfly valve 670 is preferably closed in order to prevent a significant amount of oxygen from entering the chamber. Then the second butterfly valve 904 is opened and the carbonized material is discharged, for example into another vibrating conveyor (not shown).

If desired, another chute 684 may be provided at the upstream end of the heating chamber with an expansion coupling 702 and a butterfly valve 686 provided beneath the chute 684. The chute 684 and associated valves and vibratory conveyor operate substantially the same as the chute 668 and valves 670, 904 and the vibratory conveyor 902.

A cylinder 690 opens and closes the butterfly valve 686. In the preferred embodiment, a vibratory conveyor 906 is provided below the butterfly valve 686 with one end of the vibratory conveyor receiving the carbonized product from the butterfly valve. When the butterfly valve 686 is open, the carbonized product may pass onto the vibratory conveyor 906 where the carbonized material is cooled. The other end of the vibratory conveyor 906 provides carbonized material to a second butterfly valve 908.

To discharge the carbonized product, the first butterfly valve 686 is preferably closed in order to prevent a significant amount of oxygen from entering the chamber. Then the second butterfly valve 908 is opened and the carbonized material is discharged, for example into another vibrating conveyor (not shown).

The second chute 684, if provided, collects any waste material which falls off of the conveyor at the upstream end or which falls off of the paddles 712 as the paddles move along the bottom of the heating chamber and helps to prevent fouling of the conveyor.

The conveyor chains are driven by a pair of upstream gear wheels 716 and a pair of downstream gear wheels 740. The upstream gear wheels 716 are carried on an axle 724 which is cooled, as needed, by passing a cooling fluid through a central passageway extending through the axle 724.

The bottom of the heating chamber includes a layer of ceramic material 706, 707, 709. Insulating material 704 (such as fiberglass or wool) is provided on the outside of the heating chamber adjacent the layer of ceramic material 706, 707, and 709.

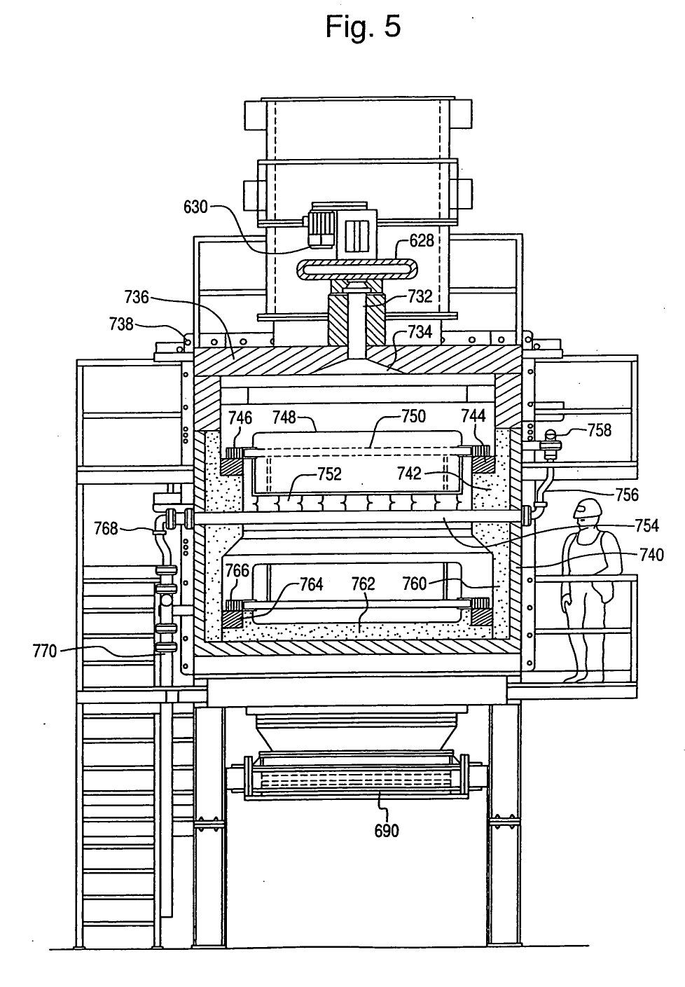

With reference now to FIG. 5, the piping 628 provided at the upper portion of the heating chamber is provided with a vacuum by the fan (or pump) 630. The piping 628 communicates with a vertically oriented chimney 732 which is provided above a collection funnel 734 which directs the gases given off by the heated waste materials.

The upper portion of the heating chamber is formed of insulating material 736 with an outer cover of sheet metal which is bolted together periodically along flanges 738. The lower portion of the heating chamber is lined with insulating material 740 on the outside of refractory members 742. Additional refractory members 760, 762 form the lower portion of the heating chamber. The upper refractory members 742 provide a ledge along the left and right sides of the heating chamber which carry bearing members 744 for links 746 of the chains of the conveyor. The paddles 748 include a sheet member 750 which extends horizontally between the chains of the conveyor. The chains slide on the bearing members 744.

The ceramic bed for the heating chamber is formed by interlocking members 752 which extend longitudinally along the middle of the heating chamber. Piping 754 extends horizontally below the ceramic bed to provide cooling fluid which cools the metal support structure for the ceramic bed. The cooling fluid is provided by piping 758 which is connected to a flexible hose 756. The cooling fluid exits the piping 754 through a fitting 768 and then through piping 770. Another flexible coupling member is provided on the downstream side of the piping 754.

The lower refractory members 762 also provide a ledge 764 which supports the links 766 of the chains along the lower portion of the conveyor. While traveling along the lower portion of the heating chamber, the paddles are inverted and remain fixed with respect to the associated chain links of the conveyor. Each of the paddles is relatively heavy and may weigh more than 100 kilograms. In the preferred embodiment, a spacing of about 10 mm to 12 mm is preferably provided between the inner rounded edge of the paddle and the adjacent surface of the ceramic trough or channel.

Suitable refractory ceramic cements are available commercially. A particularly good refractory ceramic cement is used on the Space Shuttle and is relatively expensive. However, the superior hardness and heat resistance of that ceramic cement makes it particularly desirable for use in the heating chamber according to the present invention.

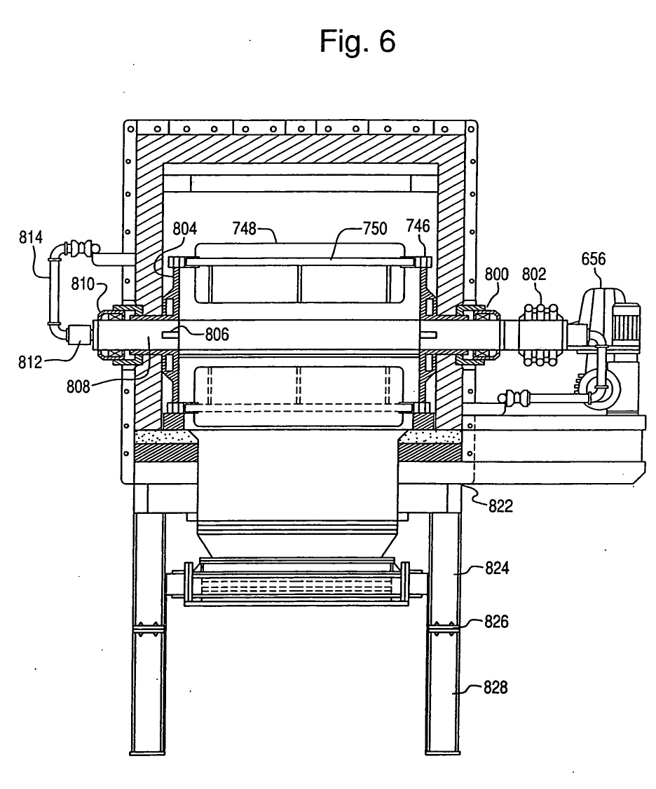

With reference now to FIG. 6, the downstream end of the heating chamber is shown in cross section through the axle of the gear wheels. The axle is carried in gear blocks 800, 810. The gear wheels have teeth 804 which engage the chain links and the gear wheels are keyed to the axle 808 at keys 806. A rotatable coupling 812 for the cooling piping connects the upstream side of the axle with a flexible hose 814 and fittings. Pulley wheels 802 are provided on the axle to enable the electric motor 656 to rotate the axle and drive the chains within the heating chamber.

In order to raise the heating chamber above ground level, a framework is formed of structural members which support the heating chamber and the associated walkways, etc. The structural framework is formed by vertical members 824, 828 which are bolted together at a connection 826. The vertical members carry horizontal members 822 which support the underside of the heating chamber.

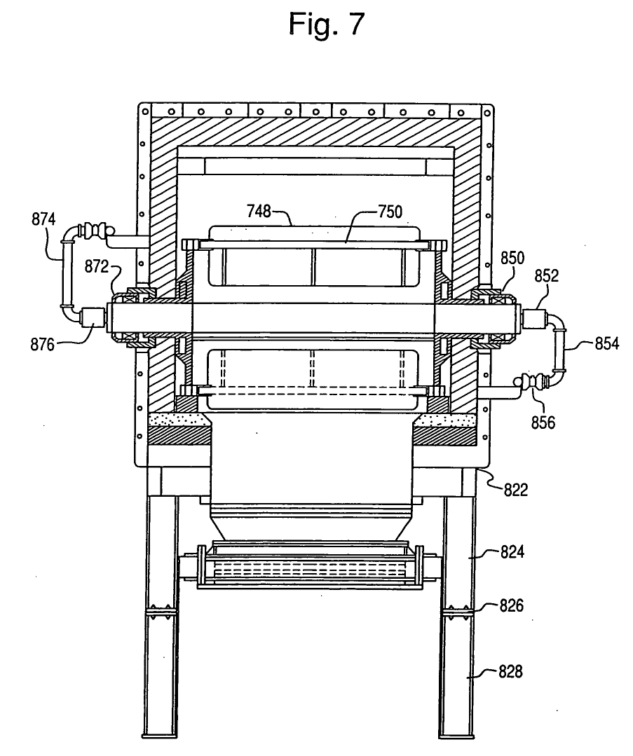

With reference now to FIG. 7, a cross sectional view of the upstream end of the heating chamber is provided. The gear wheels for the upstream end of the conveyor are not driven and so they are carried on an axle which is provided in gear blocks 850, 872. As noted in connection with FIG. 6, the piping through the axle for the gear wheels is connected to flexible hoses 854, 874 through rotatable couplings 852, 876. A valve 856 is provided to control communication of the piping 854 with a downstream piping for the cooling fluid.

During the heating of the waste material in the chamber, the waste material is partially (or completely) dissociated into gases with some amount of solid material remaining. The dissociation process is carried out in with little or no oxygen and preferably at a pressure which is below atmospheric pressure. If desired, nitrogen or an inert gas may be supplied to the interior of the heating chamber to completely or substantially replace the air otherwise within the heating chamber.

Preferably both the combustion gases and the remaining carbonizing product are recovered and burned in a combustion chamber in order to produce useable energy. For example, the combustion of the gases (and some or all of the remaining solid material) in a combustion chamber may be used to heat steam to produce electricity. The heat recovered from the combustion process may also be used to dry the waste material prior to processing or for the heating of a dwelling or other structure.

The dissociation process, typically called “thermolysis”, occurs at a temperature of between 400° C. and 1000° C. Frequently, the dissociation process occurs at a temperature of about 500° C. although the preferred temperature as well as the amount of time that the waste material is processed within the heating chamber depends upon the composition of the waste material and the initial size of the particles of waste material. For example, when processing shredded tires, the dissociation process is performed at a temperature of about 525° C. for a period of about thirty minutes. The heating chamber according to the preferred embodiment of the present invention is made from materials which generally tolerate high temperatures up to about 1200° C. In addition, the equipment is sized to generate about 5 megawatts of energy from the combustion of the gases recovered from the treatment of shredded automobile tires. Preferably, about 50 kilograms of shredded tires are treated in each batch between adjacent paddles and the device can process about 3 tons of material per hour (or about 24,000 tons of shredded tires per year).

Depending upon the composition of the waste material and the applicable pollution control regulations, it may be desirable to add chemicals such as calcium carbonate to the waste material prior to being supplied to the heating chamber. These chemicals may tend to neutralize atoms or molecules such as sulfur or halogens which can produce undesirable molecules in the atmosphere such as sulfur dioxide, hydrogen chloride, or hydrogen fluoride.

More specifically, when the starting material comprises a pollutant, the treatment by thermolysis makes it possible to concentrate the pollutant in one of the two by-products, generally the solid by-product, and thus to carry out the treatment of the flue gases on only a portion of the products and not on all the products, which is reflected by an appreciable saving.

The solid carbonaceous product obtained after thermolysis can advantageously be separated into two by-products, a non-combustible product and a combustible product, only the said combustible product being conveyed into the combustion chamber, the noncombustible product being upgraded.

Thus, in the case of the treatment of automobile shredder residues, the non-combustible metal is separated from the combustible fraction, which makes it possible to improve the output and the efficiency of the plant.

In a simplified embodiment, the thermolysis gases and the solid carbonaceous residues produced by the reactor are conveyed to the same combustion chamber which feeds one and the same steam generator. In an alternative form, the combustion chamber comprises two furnaces, respectively a first furnace for the solid carbonaceous products and a second for the gases.

This separate combustion of the two by-products, gaseous and solid respectively, makes it possible to optimize the quality of the combustion and consequently the outputs. The hot combustion gases are subsequently combined in order to be upgraded in the form of energy for the production of steam or of hot water.

As already said, before combining the hot combustion gases, it is possible, after having separated the polluting solid by-product, to treat the flue gas resulting from the combustion of this by-product in a unit for the treatment of flue gases, which unit is intended to recover the pollutants in order for them to be disposed of on a landfill site for final waste.

In the preferred embodiment, the conveying channel for the heating chamber is built with refractory cement. To reduce abrasion, ceramic refractory materials are used for the conveying channel. However, ceramic refractory materials have a low mechanical resistance to flexing (i.e., a low resistance to flexion). Accordingly, ceramic refractory materials are usually used as covering materials and therefore a mechanical support system has to be added to support the channel.

In the preferred embodiment, the mechanical support system for the ceramic refractory channel is formed of metallic support members, with a cooling system comprising piping which provides cooling fluid through the metallic support members. The metallic support members may comprise beams or U-shaped members which compensate for the inadequate mechanical characteristics of the refractory cement channel members. To prevent the metallic support members from overheating and consequently sagging or becoming deformed, the metallic support members are cooled with a thermal fluid. The cooling maintains the metallic support members within a temperature range in which the metal retains suitable mechanical characteristics and is able to support the weight of the refractory cement channel.

In the preferred embodiment, energy is recovered from the cooling system, in order to increase the overall thermal efficiency of the system. Due to the typical temperature of the heating chamber and the dimensions of the metallic supporting members, the use of a cooling fluid may not be economically viable without a recovery of the thermal energy absorbed by the cooling fluid from the heating chamber.

If air is used at the cooling fluid, the hot air (after passing through the heating chamber to cool the metallic structural members) is used as preheated combustion air. As a result, the thermal efficiency of the combustion chamber, and consequently the thermal efficiency of the whole process, is improved. In particular, the use of the heated cooling air in the combustion chamber not only improves the combustion of the gases but also reduces the amount of pollution (for example, less nitrogen oxides) in the resulting combustion gases coming from the combustion chamber.

If the cooling fluid is not air, thermal energy can still be recovered from the cooling fluid and then either used to heat air supplied to the combustion chamber or used in other thermal processes (such as the drying of the waste material, heating of a structure, etc.).

In the preferred embodiment, the paddles carried by the conveyor chains are asymmetrical which provides a relatively larger treatment capacity for the heating chamber. In the preferred embodiment, the heating chamber has a relatively long treatment channel which is supported with cooled metallic structural members. The asymmetric design of the paddles enables the paddles to present a relatively wide surface between the conveyor chains and the surface of the ceramic channel (on the upper portion of the conveyor chains). Accordingly, the volume of the individual batches of waste material carried between adjacent paddles, and consequently the treatment capacity of the heating chamber is increased. When traveling along the lower portion of the conveyor chains, the paddle width between the chains and the refractory surface corresponds to the preferred distance between the chains and the refractory surface to prevent the chains from unduly sagging between the conveyor gear wheels.

As noted above, the additional chute and collection arrangement for waste material beneath the upstream end of the conveyor provides a system which avoids a fouling of the conveying system along the lower return path for the conveyor. The additional chute and collection arrangement enables the collection and evacuation of materials that have not followed the normal conveying path, i.e., waste particles and pieces that are stuck on the conveyer, etc. Those materials may accumulate, over time, in the space located between the conveyor and the lower refractory channel and eventually foul the system requiring a shut down and cleaning of the heating chamber to remove such accumulated waste materials.

The additional chute and collection arrangement includes a “tank” with an access door. The “tank” is located below the upstream gear wheel of the conveyer chains. As the paddles move toward the upstream end of the heating chamber, the paddles gather any remaining waste materials and push them toward the upstream end of the heating chamber until the waste materials fall into the collection tank. Similarly, any waste particles that may have stuck to the paddles after the normal exit of remaining waste materials in the downstream chute and collection arrangement.

The use of ceramic materials and the configuration of the paddles and channel reduce the abrasion and the corrosion of the conveying system. Because of the treatment capacity and the operating conditions of the heating chamber, the conveying system (chains and paddles) is built with strong and relatively heavy metallic members. While moving along the length of the heating chamber, the chains and the paddles must be supported or the weight of the chains and the paddles, combined with the heat of the heating chamber, would produce significant deformations and elongation of the chains and paddles.

For this reason, rollers of the ends of the paddles (extending beyond the chains) ride on supporting tracks which permit the sliding of the chains. Since the paddles are connected to the chains, the supporting tracks also support the weight of the paddles and maintain the appropriate position of the paddles relative to the ceramic channel.

In order to minimize the friction and to limit abrasion and wear, the supporting track is made of ceramic refractory cement. In addition, the conveyor chains are intentionally exposed to the gases given off from the waste material in the heating chamber so that the gases communicate with the conveyor chains. In this way, carbon dust which comes from the carbonization of the waste material will coat the surfaces of the conveyor chains and the carbon dust then acts as a lubricant agent between the metal of the chains and the supporting surface of the refractory cement and the channel.

In the preferred embodiment of the present invention, the metal supporting structure is cooled by passing a fluid through the chamber adjacent to the metal supporting structure. The cooling fluid is heated while passing through the chamber and at least some of that heat is preferably recovered by supplying the (heated) cooling fluid to the combustion chamber. The overall thermal efficiency of the waste treatment process is improved by recovering at least some of the heat of the “cooling fluid” either in a heat exchanger or in the combustion chamber.

The cooling fluid is provided in order to cool the metal support structure and is not provided to cool the U-shaped material supporting surface (i.e., the ceramic bed). By cooling the metal support structure, the horizontal support members may maintain their mechanical properties despite being located in an “oven”. Accordingly, the metal support structure can support the weight of the U-shaped material support surface (the ceramic bed) without significant deformation or loss of strength.

While the invention has been described in detail with reference to specific embodiments thereof, it will be apparent to one skilled in the art that various changes and modification may be made, and equivalents thereof employed, without departing from the scope of the claims.

What is claimed is:

1. A chamber for treatment of waste material, comprising:
a substantially closed chamber, said substantially closed chamber being horizontally elongate;
a conveyor provided within said substantially closed chamber, said conveyor being oriented generally horizontally and defining an upper portion and a lower portion, said conveyor having a series of paddles arranged to move material along said upper portion of said conveyor; and,
a material supporting surface provided between said upper portion and said lower portion of said conveyor, said material supporting surface being arranged beneath said upper portion of said conveyor, said material supporting surface being formed of ceramic material

2. The chamber of claim 1 wherein said material supporting surface is formed of ceramic cement.

3. The chamber of claim 1 wherein said material supporting surface is carried by a plurality of horizontal support members which extend transversely across the chamber.

4. The chamber of claim 3 wherein said plurality of horizontal support members are made of metal and further comprising passageways for supplying a fluid in thermal contact with at least one of said plurality of horizontal support members.

5. The chamber of claim 4 wherein a passageway for supplying a cooling fluid is provided in thermal contact with each of said plurality of horizontal support members.

6. The chamber of claim 4 wherein said material supporting surface is generally U-shaped and forms a channel through which the paddles move along the upper portion of the conveyor.

7. The chamber of claim 5 further comprising an arrangement to recover thermal energy from said cooling fluid after passing through said passageways in thermal contact with said plurality of horizontal support members.

8. The chamber of claim 1 wherein said paddles are asymmetrically oriented with respect to said conveyor.

9. The chamber of claim 8 wherein said conveyor comprises first and second chains with said paddles provided between said first and second chains, said paddles being oriented perpendicularly with respect to the first and second chains.

10. The chamber of claim 9 wherein a relatively large portion of each of said paddles extends perpendicularly from said chains toward said material supporting surface.

11. The chamber of claim 10 further comprising a second supporting surface provided beneath the lower portion of the conveyor, a relatively small portion of each of said paddles extending perpendicularly from said chains away from said material supporting surface.

12. The chamber of claim 11 wherein said relatively small portion of each of said paddles urges remaining waste material along the second supporting surface and into the arrangement to collect remaining waste material from the upstream end of the conveyor to prevent fouling of the conveyor.

13. The chamber of claim 9 wherein said first and second chains are carried on ceramic bearing surfaces provided longitudinally within said chamber.

14. The chamber of claim 13 wherein carbon formed during heating of the waste material within the chamber provides lubrication for the chains of the conveyor on the bearing surfaces.

15. The chamber of claim 1, further comprising:
an arrangement to recover gases from an upper portion of said chamber; and
a combustion chamber for burning said recovered gases.

16. The chamber of claim 15, further comprising:
an arrangement to supply at least a portion of the remaining waste material from the downstream end of the conveyor to the combustion chamber.

17. The chamber of claim 16, further comprising:
an arrangement for recovering thermal energy from combustion gases supplied by said combustion chamber; and
an arrangement for removing pollution from said combustion gases.

18. A chamber for treatment of waste material, comprising:
a substantially closed chamber, said substantially closed chamber being horizontally elongate;
a conveyor provided within said substantially closed chamber, said conveyor being oriented generally horizontally and defining an upper portion and a lower portion, said conveyor having a series of paddles arranged to move material along said upper portion of said conveyor;
a material supporting surface provided between said upper portion and said lower portion of said conveyor, said material supporting surface being formed of ceramic cement and arranged beneath said upper portion of said conveyor, said material supporting surface being generally U-shaped and forming a channel through which the paddles move along the upper portion of the conveyor;
an inlet whereby a discrete batch of waste material may be periodically supplied to the conveyor;
an arrangement to substantially prevent oxygen from entering said chamber;
an arrangement to heat the interior of the chamber;
piping to collect gases given off by the waste material while being conveyed through the chamber; and,
an arrangement to collect remaining waste material from a downstream end of said conveyor.

19. The chamber of claim 18 wherein said arrangement to heat the interior of the chamber comprises a plurality of electrical resistance heating elements arranged into individually controlled groups.

20. The chamber of claim 19 wherein said material supporting surface is carried by a plurality of horizontal support members which extend transversely across the chamber, said plurality of horizontal support members being made of metal and further comprising passageways for supplying a cooling fluid in thermal contact with at least one of said plurality of horizontal support members.

21. The chamber of claim 18 wherein said paddles are asymmetrically oriented with respect to said conveyor, said conveyor comprising first and second chains with said paddles provided between said first and second chains, said paddles being oriented perpendicularly with respect to the first and second chains.

22. The chamber of claim 21 wherein a relatively large portion of each of said paddles extends perpendicularly from said chains toward said material supporting surface and further comprising a second supporting surface provided beneath the lower portion of the conveyor, a relatively small portion of each of said paddles extending perpendicularly from said chains away from said material supporting surface.

23. The chamber of claim 18 wherein carbon formed during heating of the waste material within the chamber provides lubrication for the chains of the conveyor on the bearing surfaces.

24. A method for operating a chamber for treatment of waste material, comprising the steps of:
heating a substantially closed chamber, said substantially closed chamber being horizontally elongate;
driving a conveyor provided within said substantially closed chamber, said conveyor being oriented generally horizontally and defining an upper portion and a lower portion, said conveyor having a series of paddles arranged to move material along said upper portion of said conveyor;
providing a material supporting surface between said upper portion and said lower portion of said conveyor, said material supporting surface being arranged beneath said upper portion of said conveyor, said material supporting surface being formed of ceramic material;
supplying a cooling fluid in thermal contact with at least one of a plurality of horizontal support members within said chamber;
periodically supplying a discrete batch of waste material to the conveyor;
substantially preventing oxygen from entering said chamber;
collecting gases given off by the waste material while being conveyed through the chamber; and
collecting remaining waste material from a downstream end of said conveyor.

25. The method of claim 24 further comprising the step of collecting remaining waste material from an upstream end of said conveyor, wherein a relatively small portion of each of said paddles urges remaining waste material along the second supporting surface and into the arrangement to collect remaining waste material from the upstream end of the conveyor to prevent fouling of the conveyor; further comprising the steps of:
recovering gases from an upper portion of said chamber;
recovering heat energy from said cooling fluid after said cooling fluid has been in thermal contact with said at least one of a plurality of horizontal support members within said chamber, whereby thermal efficiency of the method for operating a chamber for the treatment of waste material is improved; and
burning said recovered gases in a combustion chamber.

26. The method of claim 24 further comprising the step of sliding first and second chains of said conveyor on ceramic bearing surfaces provided longitudinally within said chamber, and further comprising the step of lubricating the chains of the conveyor with carbon formed during heating of the waste material within the chamber.
